(19) United States
(12) Patent Application Publication
(10) Pub. No.: US 2012/0121224 A1
(43) Pub. Date: May 17, 2012

(54) CABLE INTEGRATING FIBER OPTICS TO POWER AND CONTROL AN ELECTRICAL SUBMERSIBLE PUMP ASSEMBLY AND RELATED METHODS

(76) Inventors: Larry V. Dalrymple, Claremore, OK (US); David H. Neuroth, Clayton, NY (US)

(21) Appl. No.: 13/272,076

(22) Filed: Oct. 12, 2011

Related U.S. Application Data
(60) Provisional application No. 61/413,117, filed on Nov. 12, 2010.

(51) Int. Cl. G02B 6/44; H01B 13/00; F04B 35/04; H01B 13/26

(52) U.S. Cl. 385/101; 156/53; 156/47; 417/410.1

(57) ABSTRACT

Embodiments of the present invention include a cable for connecting a downhole electrical submersible pump assembly to a control station the cable comprising a plurality of leads disposed in the cable, the plurality of leads disposed in a position that is substantially parallel to each of the other leads, each of the leads being separated by a distance, and each of the leads adapted to carry three phase electrical power to the electrical submersible pump; a plurality of insulated spacers disposed in between each of the leads, the insulated spacers having a width; the insulated spacers having a cross-section that is substantially shaped like an hourglass; and a plurality of optical fibers disposed substantially in the center of each of the spacers, the optical fibers adapted to sense the conditions of the well and electrical pump assembly, the fiber producing an optical signal for receipt by a downhole control circuit positioned near the motor.

### CROSS REFERENCE TO RELATED APPLICATIONS

This application claims priority to U.S. Provisional Patent Application No. 61/413,117 titled “A Cable Integrating Fiber Optics to Power and Control an Electrical Submersible Pump Assembly and Related Methods filed on Nov. 12, 2010, which is incorporated herein in its entirety.

### BACKGROUND

1. Field of Invention

The present invention relates, in general, to electrical submersible pumps (ESPs) and more particularly to cables for providing power and control signals to an ESP pump assembly.

2. Description of the Prior Art

Submersible pumps are often used in deep wells for pumping large volumes of liquid to the surface. Often, the pump assembly will be located several thousand feet into the well. The pump assembly normally includes a centrifugal pump, below which is mounted a large alternating current electrical motor for driving the pump. The alternating current is supplied via a three-phase power cable. The power cable may be round in cross-section or flat. Normally, a steel outer armor strips wrap around insulated conductors. In flat cable, insulated conductors may be sheathed in lead, particularly for wells having significant hydrogen sulfate.

Sensing equipment may also be located around the motor or in the wellbore, and may be connected to a control station using either a phase of the three-phase power cable, or a dedicated wiring system. For example, fiber optic sensors may be used to measure downhole temperatures, and other variables. The fiber optic sensors typically have fiber optic cable running from a control station at the surface downhole along the outside of the production tubing. This means that in addition to the power cable, engineers must make room in the wellbore for the fiber optic cable. Moreover, such fiber optic cable must be adequately sheathed to protect the cable from the downhole environment, and ensure that the fiber is operational. A smaller line, such as a fiber optic line, can be incorporated within a 3-phase ESP power cable. However, the power cable bends when stored on a reel and during installation which could damage the fiber optic line.

### BRIEF DESCRIPTION OF DRAWINGS

Some of the features and benefits of the present invention having been stated, others will become apparent as the description proceeds when taken in conjunction with the accompanying drawings, in which:

FIG. 1 is a schematic side view of an ESP assembly constructed in accordance with an embodiment of the present invention;

FIG. 2 is a perspective view of a cable with some of the layers exposed according to an embodiment of the invention;

FIG. 3 is a transverse sectional view of the cable of FIG. 4 taken along an axis defined by A-A′ according to an embodiment of the present invention;

FIG. 4 is a block diagram of a well production system using a cable to monitor sensors and communicated with a surface controller according to an embodiment of the invention;

FIG. 5 is a transverse sectional view of an alternate embodiment of a cable, showing fiber optic lines installed in a lead sheathed cable assembly; and

FIG. 6 is a longitudinal sectional view along a B-B′ section of the power cable shown in FIG. 5, which has fiber optic lines disposed in sinusoidal form.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The present invention will now be described more fully hereinafter with reference to the accompanying drawings in which embodiments of the invention are shown. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

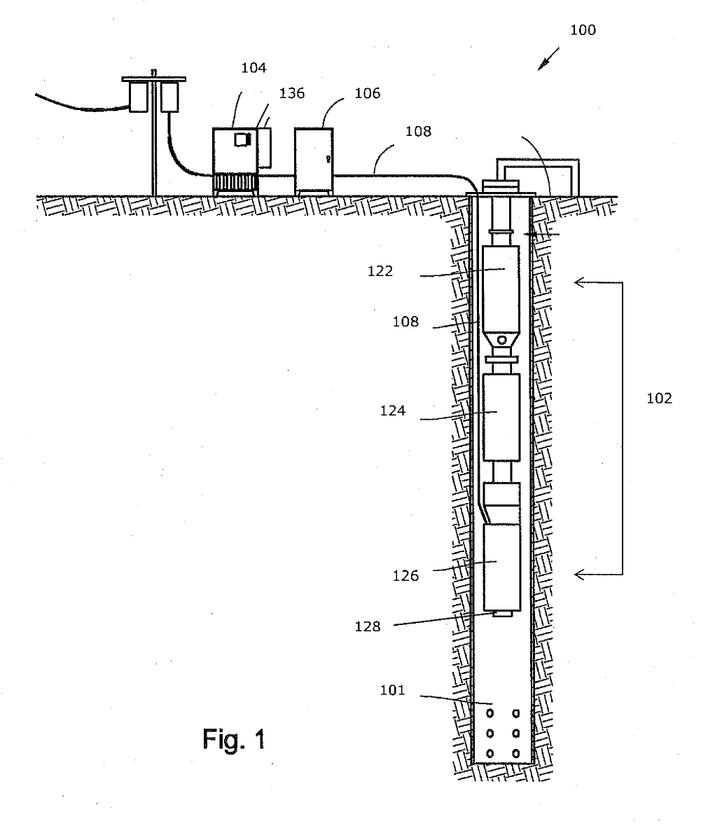

With reference now to FIG. 1, well production system 100 includes ESP 102, motor controller 104, and optionally transformer 106 connected together via power cable 108. As can be seen, ESP 102 extends vertically down into well bore 101, formed in an oil-bearing fomiation. Fluid flows from perforations in the wellbore and is lifted to the surface by ESP 102.

ESP 102 includes centrifugal pump 122, seal assembly 124, and motor 126 that is connected to AC power via power cable 108, and sensor 128. Specifically, motor 126 receives electrical power to rotate a shaft [not shown]. The rotating shaft is connected to centrifugal pump 122, which uses the rotating shaft of motor 126 to turn impellers [not shown] that apply pressure to the oil and water, and lift same to the surface. Seal assembly 124 is provided between centrifugal pump 122 and motor 126 to transfer motor torque to centrifugal pump 122, as well as to equalize ESP and well bore pressure and isolate motor 126 from well fluid. Sensor 128 and any associated electronics monitor downhole conditions such as wellbore pressure, motor temperature, presence of free water, discharge flow rate, discharge pressure and vibration. Sensor 128 may be connected to motor controller 104 via power cable 108.

The operation of ESP 102 is controlled by motor controller 104, which controls power delivery to the motor and may act as a controller to monitor the operation of the well pump and the condition of the pump components. Motor controller 104 operates as a power source for the motor by connecting to e.g., a power line delivering three-phase AC power, to deliver the power in a controlled manner, i.e., the power delivered to the motor is free from transients or is a function of some parameter such as fluid flow. Motor controller 104 may be a switchboard, soft starter, or variable speed drive such as a pulse width modulated variable frequency drive, though a variable speed drive is preferred. Data monitoring and control device 136 is part of motor controller 104 and provides the “brains” of the system, as is known in the art. As can be seen, motor controller 104 and data monitoring and control device 136 are connected to the motor and any sensors downhole via, e.g., power cable 108, disposed along the inside of wellbore 101.

Power cable 108 provides power and optionally communications between motor controller 104 and motor 126, as well as a bi-directional connection between sensors and the motor controller via optical fiber. Typically, power cable 108 connects to a motor lead extension (not shown) proximate to the pumping system. Motor lead extension continues in the well bore 101 adjacent the pump assembly and terminates in what is commonly referred to as a “pothead connection” at motor 126. As one skilled in the art will appreciate, power cable 108 typically extends thousands of feet and thereby introduces significant electrical impedance between motor controller 104 (or step-up transformer) and motor 126.

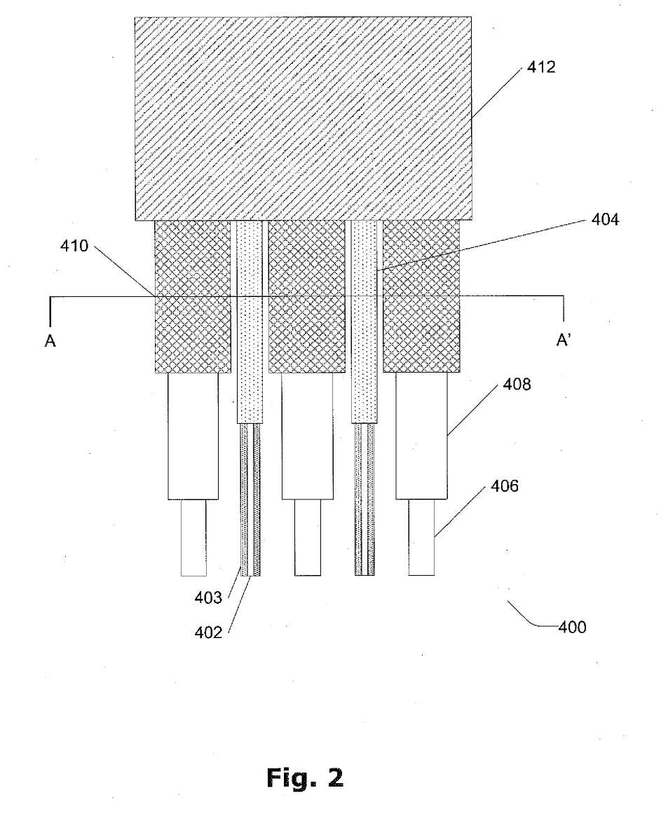

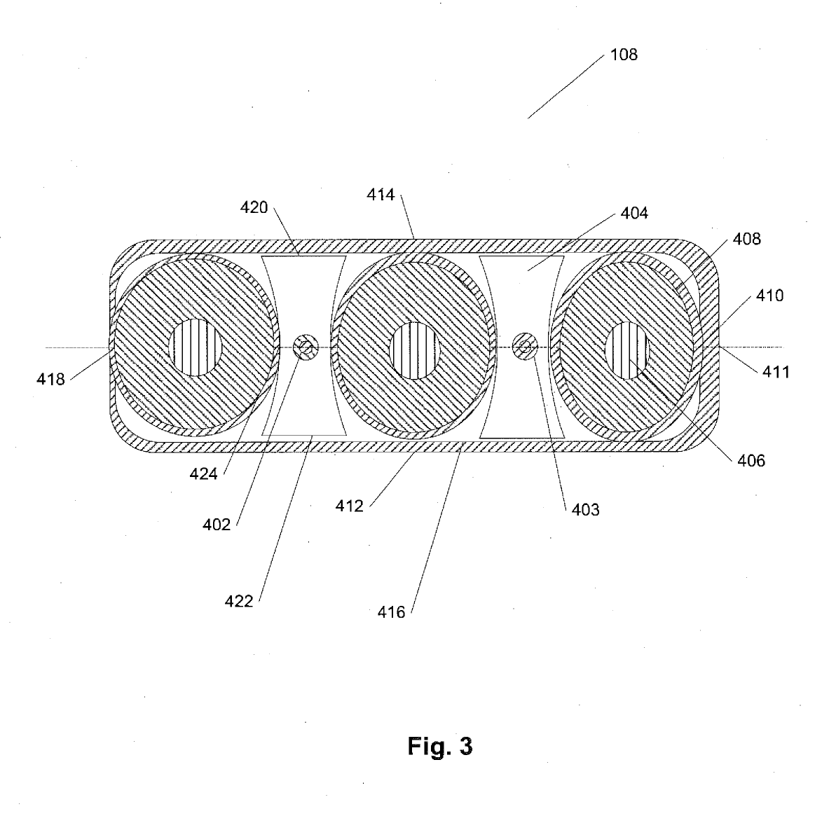

Power cable 108 will now be described with reference to FIGS. 2 and 3. In this example, power cable 108 is a flat cable that includes armor 412, having a layer of three conductors 406, insulation 408, two centering struts 404, and optical fiber 402 surrounded by a, for example, a protective tube 403. Each optical fiber 402 is provided to, for example, sense downhole conditions; provide control signals to the ESP or to provide monitoring signals to the control station. As one skilled in the art will appreciate, optical fiber 402 is, e.g., glass fiber extruded using known methods. The fiber may be wrapped to protect the glass and to make sure an optical signal stays near the optical core of the fiber, then positioned in the tube 403, which may be a protective material such as stainless steel. Each tube 403 is embedded within a centering strut 404. Strut 404 may be thermoplastic, polypropylene, or EPDM, or any other material with an appropriate temperature rating for constructing strut 404. Fiber optical tube 403 is installed when strut 404 is being extruded. Strut 404 protects the optical fiber 402 by maintaining it along a neutral bending axis 411 so that when installing power cable 108, the cable may be bent when placed on a reel for insertion through a wellhead. As such, bending of the power cable may be a radius up to 14 times its thickness. If ½ inch thickness, the bending radius may be 7 inches. The fiber optic line 402 cannot stretch. The bending will be along neutral axis 411 with the portion of the cable on the outside of the bend and axis 411 elongating and the portion of the bend on the inside of the bend and axis 411 compressing. The least force to compress and elongate the cable occurs along axis 411. Struts 404 retain optical fiber 402, generally centered on axis 411 and neutral bending axis 411 is approximately halfway between the upper side 414 and lower side 416. In this regard, if conductors 406 are copper, conductors 406 compresses more easily than they elongate, thus the inner side of the bend is on lower side 416, and the neutral axis 411 is slightly lower than the physical axis.

Conductors 406 are disposed as three “leads” for a three-phase power supply. As discussed above, power is delivered to the ESP using three-phase power. The three-phase power not only provides power downhole, but may also function as a communications link with the downhole control circuit, e.g., by modulating a control signal on one of the AC signals delivering power downhole. Conductors 406 are constructed from, e.g., copper. The conductors 406 are protected by insulator 408. Insulator 408 protects each conductor 406 from contacting another conductor and thereby forming a short circuit. As one skilled in the art will appreciated, insulator 408 is extruded over conductor 406 using, e.g, thermoplastic, polypropylene, or EPDM. Each insulator 408 optionally may be surrounded by a jacket 410. If used, jacket 410 protects each of the conductors and insulation from crude oil, natural gas, water, etc., and provides cable strength. Jackets may be manufactured from, for example, lead, nitrile, polyethylene, thermoplastic, EPDM or the like. Finally, the insulated conductors are covered by a common armor 412. Armor 412 comprises helically wrapped strips and provides protection of the cable components from damage, and can be constructed from, e.g., stainless steel.

The orientation of the components will now be discussed with reference to the Figures. As can be seen, the cable has a flat top surface 414, a flat bottom surface 416, and two flat side surfaces 418 providing a generally rectangular configuration. The three insulated conductors 406 for the three-phase power 406 are oriented on the outsides and middle of the cable with the optical fibers 402 disposed in between the leads. Specifically, the conductors 406 in combination with insulators 408 (the “wire/insulator combination”) are disposed parallel to one another, at substantially similar, height within the cable, with each conductor 406 having an insulator 408 disposed there around, so that the wire/insulator combinations are completely surrounded by jacket 410 and armor 412. Each wire/insulator combination 406/408 located closest to the side surfaces 418 is positioned so that it has substantially the same space between the wire/insulator combination and the side surface of the cable, and is positioned so that the outer edge of the insulator 408 is equidistant from both the top surface 414 and the bottom surface 416. The conductor/insulator combination 406/408, located in the middle of the wire/insulator combinations closest to the side surfaces 418, is positioned so that the outer edge of insulator 408 is also equidistant from the top surface 414 and bottom surface 416. In each of the wire/insulator combinations 406/408, the conductor lead 406 is disposed approximately in the center of the circumference formed by insulator 408. Axis 411 passes through a portion of each conductor 406, but not precisely in the center.

Each wire/insulator combination 406/408 is separate from adjacent wire/insulator combinations by the same distance. Disposed in between each of the wire/insulator combinations 406/408 is the strut 404 and optical fiber 402. Optionally, there may be more than one optical fiber 402, positioned in each centering strut 404. Strut 404 has a top surface 420, a bottom surface 422, and a side surface 424. In the first embodiment, strut 404 has a cross-section that is substantially an hourglass shape, so that each side 424 of the strut 404 conforms to one of the curved portions of the insulated conductors 406. In this way, the strut 404 acts as a spacer for each of the insulated conductors 406/408 and houses the optical fiber 402. Each of the optical fibers 402 is positioned within one of the struts 404 so that the optical fiber 402 is approximately equidistant from the top surface 420 and bottom surface 422 of the strut 404, and equidistant from the side surfaces 424; this positioning is approximately on neutral bending axis 411.

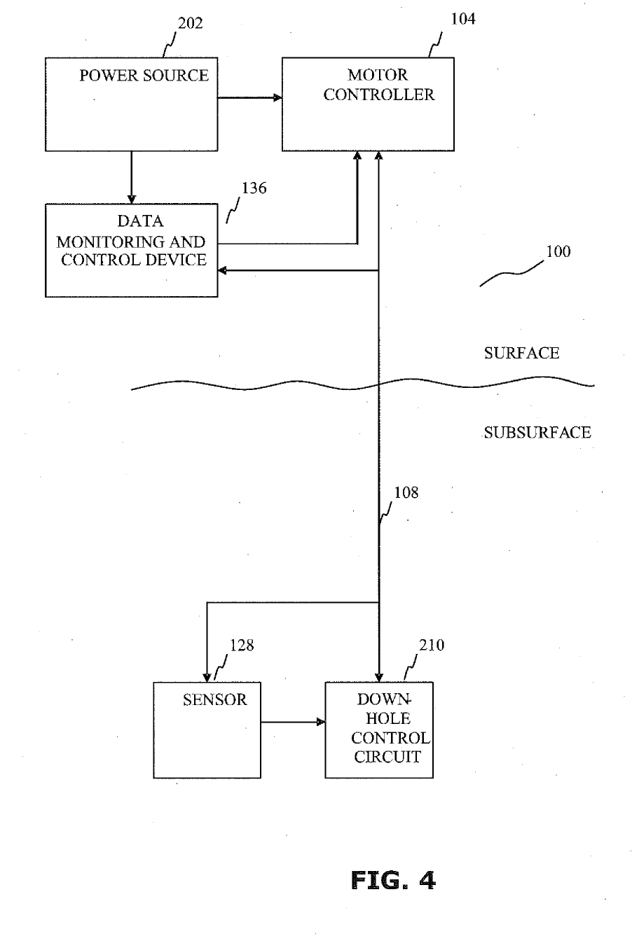

The operation of the power cable will be described with reference to FIG. 4. Motor, downhole control circuit 210 and sensor 128 are connected to data monitoring and control device 136 via the power cable 108. The motor may be connected to the three motor leads 406 at the pothead connection, and sensors 128 or downhole control circuit 210 may be connected to the optical fiber 402. Sensor 128 can be any temperature, vibration, rotational, or pressure sensors, such as an accelerometer, a strain gauge, a thermocouple, thermister, piezo, fiber optic sensor or the like. As is understood in the art, each of these sensors emits an electrical signal to e.g., optical fiber in the power cable, in response to a change in a sensed condition and therefore can monitor pump discharge pressure, pump intake pressure, tubing surface pressure, vibration, ambient well bore fluid temperature, motor voltage and/or current, motor oil temperature, etc.

Alternatively, downhole control circuit 210 may be connected to the optical fiber and either receive signals for downhole pump operation or processes the signal received from sensor 128 to output signals that are significant for data collection purposes, i.e., excludes transients and signals that indicate operation well within a normal range, for propagation to the data monitoring and control device 136 using the optical fiber. As such, the downhole control circuit 210 may comprise memory, program product, microprocessor, A/D converter, and modulator. The downhole control circuit 210 may also receive signals from the data monitoring and control device 136, propagated using the optical fiber, and processes the signal, e.g., sends the signals to downhole equipment including the motor controller, to adjust the speed of the motor, the sensors, etc. In addition, the downhole control circuit 210 may convert a monitoring signal received from sensor 128 into a signal that may be transmitted using the optical fiber for communication with the data monitoring and control device. In this way, the data monitoring and control device and the control circuit 210 may communicate using the optical fiber.

As one skilled in the art will appreciate, data monitoring and control device 136 is really the “brains” of the well production system, and controls motor controller 104 by controlling such parameters as on/off, frequency (F), and/or voltages each at one of a plurality of specific frequencies, which effectively varies the operating speed of the motor [not shown]. Data monitoring and control device 136 is powered via power source 202 and may monitor the optical fiber or power cable 108 for data signals indicative of a downhole sensed condition. The process of demodulating signals from power cable 108 is known and is also described in U.S. Pat. No. 6,587,037, entitled METHOD FOR MULTI-PHASE DATA COMMUNICATIONS AND CONTROL OVER AN ESP POWER CABLE and U.S. Pat. No. 6,798,338, entitled RF COMMUNICATION WITH DOWNHOLE EQUIPMENT.

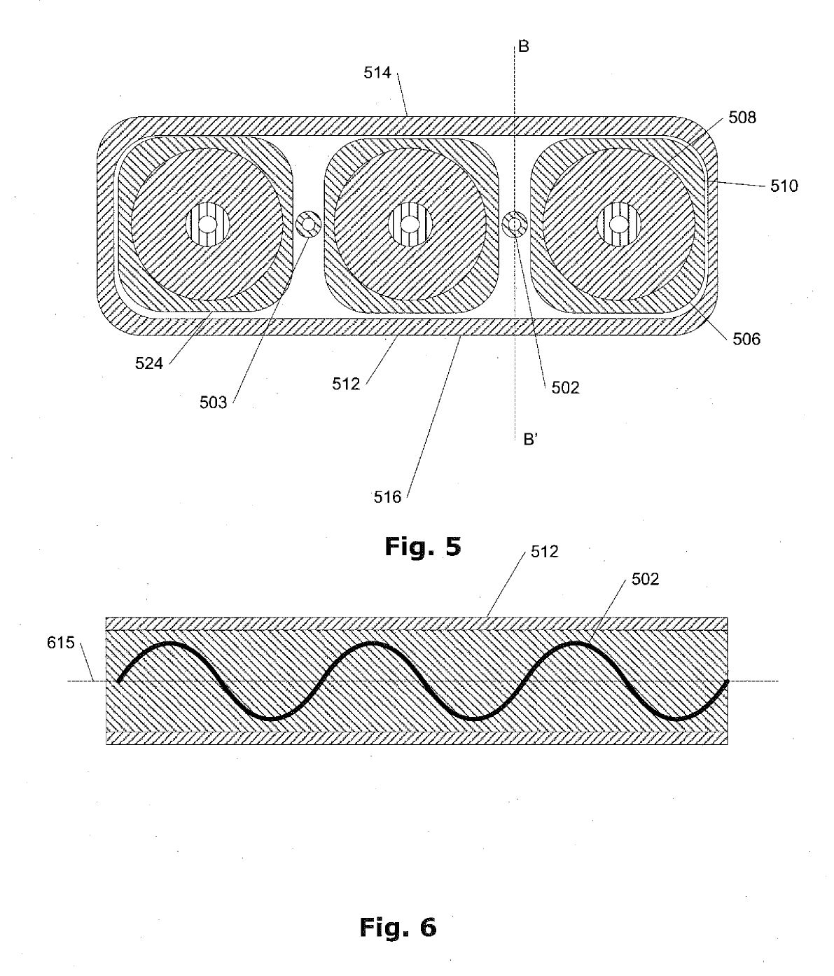

FIG. 5 shows another embodiment of power cable 108. In this example, power cable 108 is a flat cable that includes armor 512, having three conductors 506 disposed therein, insulation 508, jacket 510, and two optical fibers 502. Each optical fiber 502 is provided to, for example, sense downhole conditions; provide control signals to the ESP or to provide monitoring signals to the control station. As one skilled in the art will appreciate, optical fiber 502 is, e.g., glass fiber extruded using known methods. The fiber may be wrapped to protect the glass and to make sure an optical signal stays near the optical core of the fiber, then positioned in a protective material such as a stainless steel tube 503. The optical fiber 502 is disposed in the power cable in a sinusoidal pattern. As such, bending of the power cable may be a radius up to 14 times its thickness. If ½ inch thickness, the bending radius may be 7 inches. Because the fiber optic line 502 cannot stretch, the sinusoidal disposition pattern will allow the fiber optic line to move in the direction of the bending radius to prevent the fiber from breaking. As such, the cable bending will be along neutral axis with the portion of the cable on the outside of the bend elongating and the portion of the bend on the inside of the bend compressing.

The orientation of the components will now be discussed with reference to FIG. 5. As can be seen, the cable has a flat top surface (upper side) 514, a flat bottom surface (lower side) 516, and two flat side surfaces 518 providing a generally rectangular configuration. The three insulated conductors 506 for the three-phase power 506 are oriented on the outsides and middle of the cable with the optical fibers 502 disposed in between the leads. Specifically, the conductors 506 in combination with insulators 508 (the “wire/insulator combination”) are disposed parallel to one another, at substantially similar height within the cable, with each conductor 506 having an insulator 508 disposed there around in a substantially circular shape. The wire/insulator combinations are completely surrounded by jacket 510, extruded in, e.g., a substantially rectangular configuration and fabricated from lead. All wire/insulator combinations 506/508, and their surrounding jackets 510, are encased by armor 512. Each wire/insulator combination 506/508 is located closest to the side surfaces 518 is positioned so that it has substantially the same space between the wire/insulator combination and the side surface of the cable, and is positioned so that the outer edge of the insulator 508 is equidistant from both the top surface 514 and the bottom surface 516. The conductor/insulator combination 506/508, located in the middle of the wire/insulator combinations closest to the side surfaces 518, is positioned so that the outer edge of insulator 508 is also equidistant from the top surface 514 and bottom surface 516. In each of the wire/insulator combinations 506/508, the conductor lead 506 is disposed approximately in the center of the circumference formed by insulator 508.

Each wire/insulator combination 506/508 is separate from adjacent wire/insulator combinations by the same distance. Disposed in between each of the wire/insulator combinations 506/508 is optical fiber 502. Optionally, there may be more than one optical fiber 502, positioned between each wire/insulator combination 506/508.

FIG. 6 shows the embodiment of FIG. 5 along the cross section B-B′, and is a longitudinal section view. As can be seen, here the fiber optical cable 502 is formed and disposed in a sinusoidal configuration, i.e., half of the fiber optic cable is above the longitudinal centering line 615, and half is disposed below such line. The zero point is in the neutral bending plane. In this configuration, the fiber optic cable 502 can bend without being placed in tension.

Although the present invention has been described in detail, it should be understood that various changes, substitutions, and alterations could be made hereupon without departing from the principle and scope of the invention. Accordingly, the scope of the present invention should be determined by the following claims and their appropriate legal equivalents. The singular forms “a”, “an” and “the” include plural referents, unless the context clearly dictates otherwise. Optional or optionally means that the subsequently described event or circumstances may or may not occur. The description includes instances where the event or circumstance occurs and instances where it does not occur. Ranges may be expressed herein as from about one particular value, and/or to about another particular value. When such a range is expressed, it is to be understood that another embodiment is from the one particular value and/or to the other particular value, along with all combinations within said range. Throughout this application, where patents or publications are referenced, the disclosures of these references in their entireties are intended to be incorporated by reference into this application, in order to more fully describe the state of the art to which the invention pertains, except when these reference contradict the statements made herein.

This application claims priority to U.S. Provisional Patent Application No. 61/413,117 titled “A Cable Integrating Fiber Optics to Power and Control an Electrical Submersible Pump Assembly and Related Methods filed on Nov. 12, 2010, which is incorporated herein in its entirety.

1. A cable for connecting a downhole electrical submersible pump assembly to a control station the cable comprising:
a plurality of leads disposed in the cable, the plurality of leads disposed in a position that is substantially parallel to each of the other leads, each of the leads being separated by a distance, and each of the leads adapted to carry three phase electrical power to the electrical submersible pump;
a plurality of insulated spacers disposed in between each of the leads, the insulated spacers having a width; the insulated spacers having a cross-section that is substantially shaped like an hourglass, with the width of the spacer being narrower at a middle portion than at the top and bottom portions; and
a plurality of optical fibers disposed substantially in the middle portion of each of the spacers, the optical fibers adapted to sense the conditions of the well and electrical pump assembly, the fiber producing an optical signal for receipt by a downhole control circuit positioned near the motor.

2. A cable as in claim 1, wherein the plurality of leads are covered with insulation, the insulation being disposed between the lead and the insulated spacer.

3. A cable as in claim 2, wherein the plurality of leads are covered with a jacket, the jacket being disposed over the insulation, and the jacket being closest to the insulated spacer.

4. A cable as in claim 3, wherein the insulation is fabricated from materials selected from the group consisting of EPDM and thermoplastic, and the jacket is fabricated from materials consisting of lead, nitrile, polyethylene, thermoplastic EPDM.

5. A cable as in claim 4, wherein the insulated spacer is fabricated from thermoplastic.

6. A cable as in claim 5, wherein the leads, insulated spacers, insulation and jacket are all wrapped with a cover, the cover being disposed in contact with the jacket and insulated spacer, and being fabricated from stainless steel.

7. A cable as in claim 1, where in the plurality of optical fibers are disposed in a sinusoidal manner in the insulated spacer, with half of the lead disposed above a center line of the cable, and half of the lead disposed below the centerline of the cable.

8. An electrical control system for controlling an electrical submersible pump assembly, the control system comprising;
an electrical cable, the electrical cable comprising
a plurality of leads disposed in the cable, the plurality of leads disposed in a position that is substantially parallel to each of the other leads, each of the leads being separated by a distance, and each of the leads adapted to carry three phase electrical power to the electrical submersible pump;
a plurality of insulated spacers disposed in between each of the leads, the insulated spacers having a width; the insulated spacers having a cross-section that is substantially shaped like an hourglass, with the width of the spacer being narrower at a middle portion than at the top and bottom portions; and
a plurality of optical fibers disposed substantially in the middle portion of each of the spacers, the optical fibers adapted to sense the conditions of the well and electrical pump assembly, the fiber producing an optical signal for receipt by a downhole control circuit positioned near the motor;
a downhole control circuit positioned near the motor for receiving an optical control signal from the plurality of optical fibers, the downhole control circuit comprising a microprocessor and modulator for processing the optical signal and modulating the signal onto one of the leads to communicate the signal to a surface control station.

9. An electrical control system as in claim 8, wherein the plurality of leads are covered with insulation, the insulation being disposed between the lead and the insulated spacer.

10. An electrical control system as in claim 9, wherein the plurality of leads are covered with a jacket, the jacket being disposed over the insulation, and the jacket being closest to the insulated spacer.

11. An electrical control system as in claim 10, wherein the insulation is fabricated from materials selected from the group consisting of EPDM and thermoplastic, and the jacket is fabricated from materials consisting of lead, nitrile, polyethylene, thermoplastic EPDM.

12. An electrical control system as in claim 11, wherein the insulated spacer is fabricated from thermoplastic.

13. An electrical control system as in claim 12, wherein the leads, insulated spacers, insulation and jacket are all wrapped with a cover, the cover being disposed in contact with the jacket and insulated spacer, and being fabricated from stainless steel.

14. A cable as in claim 8, where in the plurality of optical fibers are disposed in a sinusoidal manner in the insulated spacer, with half of the lead disposed above a center line of the cable, and half of the lead disposed below the centerline of the cable.

15. A method for fabricating a cable for connecting a downhole electrical submersible pump assembly to a control station the method comprising the steps of:
extruding or forming a plurality of leads;
forming a plurality of optical fibers;
disposing the plurality of optical fibers substantially in the middle portion of each of an plurality of insulated spacers, the optical fibers adapted to sense the conditions of the well and electrical pump assembly, the fiber producing an optical signal for receipt by a downhole control circuit positioned near the motor;
positioning the insulated spacers in between each of the leads, the insulated spacers having a width; the insulated spacers having a cross-section that is substantially shaped like an hourglass, with the width of the spacer being narrower at a middle portion than at the top and bottom portions; and
disposing the plurality of leads and the insulated spacers in the cable, the plurality of leads disposed in a position that is substantially parallel to each of the other leads, each of the leads being separated by a distance, and each of the leads adapted to carry three phase electrical power to the electrical submersible pump.

16. A method as in claim 15, further comprising the step of:
disposing insulation around the plurality of leads, the insulation being disposed between the lead and the insulated spacer.

17. A method as in claim 16, further comprising the step of:
covering the plurality of leads with a jacket, the jacket being disposed over the insulation, and the jacket being closest to the insulated spacer.

18. A method as in claim 17, further comprising the step of:
fabricating the insulation from materials selected from the group consisting of EPDM and thermoplastic, and
fabricating the jacket from materials consisting of lead, nitrile, polyethylene, thermoplastic EPDM.

19. A method as in claim 18, further comprising the step of:
fabricating the insulated spacer from thermoplastic.

20. A method as in claim 19, further comprising the step of:
wrapping the leads, insulated spacers, insulation and jacket with a cover, the cover being disposed in contact with the jacket and insulated spacer.
